(19) United States
(12) Patent Application Publication
(10) Pub. No.: US 2026/0246812 A1
(43) Pub. Date: Aug. 20, 2026

(54) INTEGRATING LANGUAGE MODELS AND CLUSTERING FOR ADVANCED EMAIL SECURITY

(71) Applicant: Cisco Technology, Inc., San Jose, CA (US)

(72) Inventors: Florian Becker, Prague (CZ); Jan Brabec, Praha 5 (CZ); Filip Srajer, Hradec Kralove (CZ); Jiri Mensik, Praha 4 (CZ); Pavel Prochazka, Horomerice (CZ)

(21) Appl. No.: 19/180,112

(22) Filed: Apr. 15, 2025

Related U.S. Application Data
(60) Provisional application No. 63/761,126, filed on Feb. 20, 2025.

(51) Int. Cl. H04L 9/40; H04L 41/16

(52) U.S. Cl. CPC H04L 63/1483; H04L 41/16

(57) ABSTRACT

This disclosure describes techniques for communications grouping to assist with threat detection related to communications across a network. The techniques include selecting a portion of email communications to create a communications grouping for analysis for potentially malicious content. The communications grouping may be input to a group large language model (LLM) classifier with a prompt to detect an indicator of compromise (IOC) that is common to more than one email communication of the communications grouping. An IOC may be identified by the group LLM classifier to be common to multiple suspicious email communications of the communications grouping. Based at least in part on the identified IOC, the multiple suspicious email communications may be labeled with an indication of suspicious content. As such, communications grouping techniques may improve security in network communications.

### RELATED APPLICATIONS

This Application claims priority to U.S. Provisional Patent Application No. 63/761,126, filed February 20, 2025, which is incorporated herein by reference.

### TECHNICAL FIELD

The present disclosure relates generally to threat detection in network communications, thereby improving security of a network against potential threats.

### BACKGROUND

In network environments, users may communicate information across the network. The information may originate from a computing device outside a secure network, system, or organization. For instance, a user within an organization may receive a communication, such as an email, from an outside contact or entity. A security system of the organization may be tasked with determining whether the communication poses a threat to the organization. The growing sophistication of Business Email Compromise (BEC) and spear phishing attacks poses significant challenges to organizations worldwide, as it becomes more difficult for security systems to differentiate regular communications from security risks. Techniques featured in traditional spam and phishing detection may be insufficient due to the tailored nature of modern BEC attacks, which are designed to blend in with the regular benign email traffic. The difficulty of detecting security risks can lead to inefficiency in communications, lost emails, or consuming administrative resources to analyze problematic communications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. In some cases, parentheticals are utilized after a reference number to distinguish like elements. Use of the reference number without the associated parenthetical is generic to the element. The systems depicted in the accompanying figures are not to scale and components within the figures may be depicted not to scale with each other.

FIGS. 1A and 1B illustrate component diagrams with example environments in which communications grouping concepts for email security may be employed as part of communications between network devices, in accordance with the present concepts.

FIGS. 2 and 3 illustrate flow diagrams of example methods for the use of communications grouping concepts for email security as a part of communications among network devices, in accordance with the present concepts.

FIG. 4 illustrates a computing system diagram illustrating a configuration for a data center that can be utilized to implement aspects of the technologies disclosed herein.

FIG. 5 is a computer architecture diagram showing an illustrative computer hardware architecture for implementing a computing device that can be utilized to implement aspects of the various technologies presented herein.

### DESCRIPTION OF EXAMPLE EMBODIMENTS

This disclosure describes, at least in part, a method that may be implemented by a security system in a networked computing environment that is communicatively coupled to one or more external devices and/or other computing devices. The method may include receiving email communications from the one or more external devices. The method may include selecting a portion of the email communications to create a communications grouping. The purpose of the communications grouping may be for analysis for potentially malicious content. The method may include inputting the communications grouping to a group large language model (LLM) classifier. In some examples, a prompt may also be provided to the group LLM classifier to detect an indicator of compromise (IOC) that is common to more than one email communication of the communications grouping. In response to the prompt, the method may include receiving an identified IOC determined by the group LLM classifier to be common to multiple suspicious email communications of the communications grouping. Based at least in part on the identified IOC, the method may include labeling the multiple suspicious email communications with a classification label indicating suspicious content. Finally, the method may include forwarding the multiple suspicious email communications with the classification label to respective intended recipients of the multiple suspicious email communications.

This disclosure also describes, at least in part, another method that may be implemented by a security system in a networked computing environment that is communicatively coupled to one or more external devices and/or other computing devices. The method may include receiving an email communication data flow from one or more external devices. The method may include determining initial classification labels for email communications of the email communication data flow. The method may also include creating a grouping of a portion of the email communications of the email communication data flow. The method may include using a group large language model (LLM) classifier to identify an indicator of compromise (IOC) that is common to more than one of the email communications of the grouping. The method may further include updating an individual email communication of the grouping with an updated classification label based at least in part on the IOC. Finally, the method may include sending an indication of the updated classification label to an intended recipient of the individual email communication.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for detecting suspicious communications and determining whether to classify a communication as a security risk. Classification of communication as a security risk may be difficult or inefficient when considering an email in isolation. Therefore, the disclosed techniques include organizing similar communications (e.g., emails) into meaningful groups for enhanced analysis. For example, a security system may integrate the use of grouping and large language models (LLMs) to add contextual benefit to the analysis of communications. Communications grouping can help improve the overall efficacy of the security system, including classification success for suspicious communications, efficient label propagation within groups, and anomaly detection for outliers. In general, the use of communications grouping followed by analysis with large language models can improve the detection of suspicious communications by uncovering commonalities that are indicators of compromise which would be harder to detect in isolation.

Organizations are continuously challenged by the evolving landscape of incoming communication threats such as Business Email Compromise (BEC), phishing, and spear phishing. These threats are increasingly sophisticated, often bypassing traditional detection mechanisms, which may rely on static rules or isolated analysis of emails. Recent advances in artificial intelligence (AI), specifically with generative LLMs, have very promising application potential in the email security domain. Even though email is a complex multi-modal format, the main modality is human-readable text, a format at which the LLMs excel. Stated another way, email data is relatively well-understood by LLMs. However, analyzing an email in isolation may not be sufficient in practice for a well-performing email security system.

To address these, the disclosed techniques leverage embeddings, grouping (e.g., clustering), and LLMs to group similar emails into meaningful clusters for enhanced analysis. For example, LLMs may be used post-grouping to extract insights and indicators of compromise (IOCs). The grouping enables efficient label propagation within groups, better anomaly detection by identifying outliers, and enhanced threat detection through the contextual analysis of groups. By examining groups rather than isolated emails, we can more accurately classify emails, detect IOCs, and identify campaigns that use multiple email addresses or domains, overcoming the limitations of traditional methods. This novel application of LLMs to annotate communications in groups significantly improves many capabilities as well as the efficiency of email security systems.

While existing technologies provide a robust foundation, the disclosed techniques build on the foundation by combining text embeddings, hierarchical clustering, and LLM-based insight extraction to address the complex challenges of email threat detection. By grouping emails and applying LLMs for comprehensive analysis, the disclosed techniques offer more accurate detection of phishing and BEC attacks, offering an improved solution that advances beyond traditional methods, by enhancing the modular and adaptive capabilities for BEC detection, and improving detection over analysis of emails in isolation.

Although the examples described herein may refer to a security system and/or email classification service which may be offered via computing resources in a data center, the techniques can generally be applied to any device in a network. For instance, the communications grouping security concepts are expected to work within any of a variety of email applications, communications systems, messaging systems, etc. Further, the techniques are generally applicable for any network of devices managed by any entity where data traffic is sent over a network, virtual resources are provisioned, and/or remote services are accessed. In some instances, the techniques may be performed by software-defined networking (SDN), and in other examples, various devices may be used in a system to perform the techniques described herein. The devices by which the techniques are performed herein are a matter of implementation, and the techniques described are not limited to any specific architecture or implementation.

The techniques described herein provide various improvements and efficiencies with respect to network communications. For instance, the techniques described herein may increase the security of data and/or reduce the amount of computational resource use, storage, dropped data, latency, and other issues experienced in networks due to lack of network resources, overuse of network resources, issues with timing of network communications, and/or improper routing of data. By improving network communications across a network, overall performance by and/or security related to servers and virtual resources may be improved.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

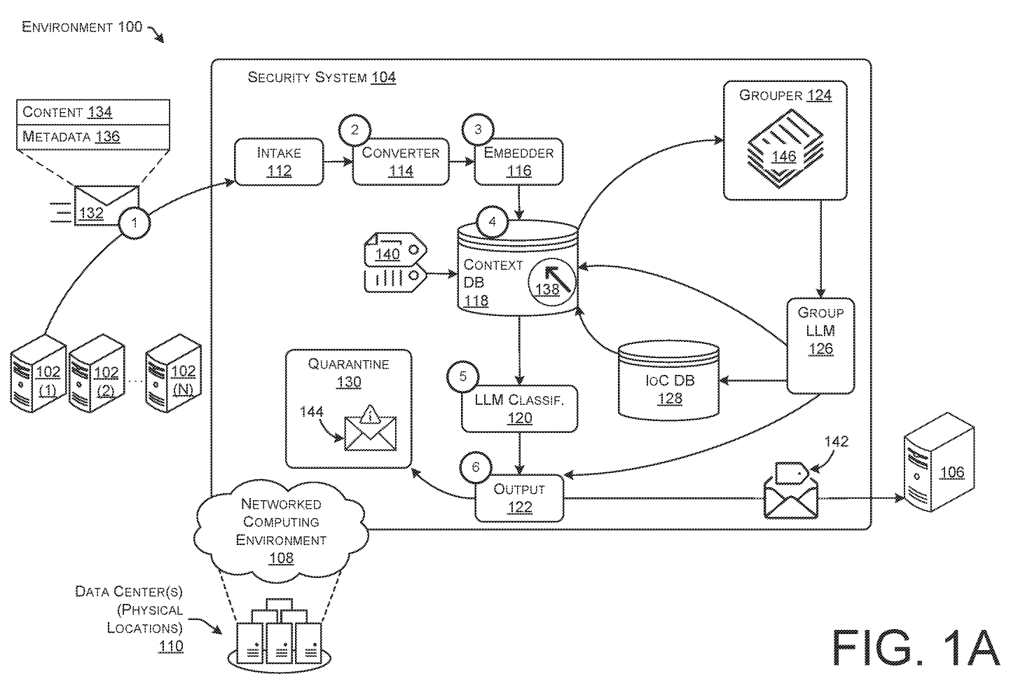

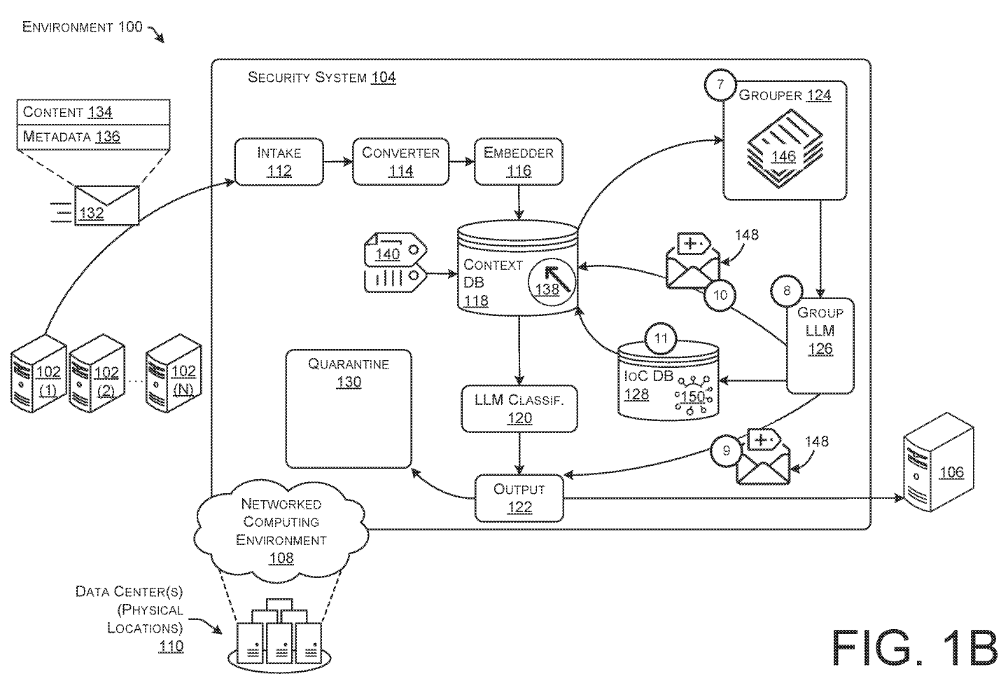

FIGS. 1A and 1B collectively illustrate an example environment 100 in accordance with communications grouping concepts for email security. As shown in FIGS. 1A and 1B, environment 100 may include one or more user devices 102, a security system 104, and a computing device 106. In some cases, parentheticals are utilized after a reference number to distinguish like elements. Use of the reference number without the associated parenthetical is generic to the element. For instance, three user devices 102 are shown, including user device 102(1), user device 102(2), and user device 102(N), where “N” refers to any integer, indicating any number of potential user devices 102. The number of elements depicted in FIGS. 1A and 1B, such as user devices 102, the services and/or devices representing security system 104, and computing device 106 is not meant to be limiting; any number of elements are contemplated in accordance with the present password linkage concepts. For instance, user devices 102 may represent any number of external devices that may send communications to security system 104 and or the networked computing environment 108. Similarly, computing device 106 may represent any number of intended recipients of the communication(s) arriving at security system 104.

The security system 104 may be viewed as a collection of services (e.g., applications, microservices, storage, database) that are provided via a networked computing environment 108, which may be manifested as one or more data centers 110 (e.g., physical locations). In some examples, the services/functions provided by the security system 104 may include intake 112, converter 114, embedder 116, context database 118 (DB), LLM classifier 120, output 122, grouper 124, group LLM 126, indicators of compromise database (IOC DB) 128, and quarantine 130, for instance. The services of security system 104 will be described in greater detail through the example(s) provided below. The security system 104 may be associated with an organization, application, or other entity. In some examples, the security system 104 may operate as a cloud-based service. In other examples, the security system 104 may be provided via an on-premise network of one or more devices. The security system 104 may be in place at least in part to protect the organization or other entity from potential threats that may arrive in communications, such as email messages.

Any of the devices and/or services of environment 100 may be communicatively coupled to various other devices of environment 100 via network connection(s). For instance, networked computing environment 108 may represent a cloud network, which may feature a variety of devices (e.g., routers, servers, computing devices, controller devices, controllers) and other network devices. Within the example environment 100, any of the devices (e.g., user device 102, the devices of data center(s) 110, computing device 106, etc.) may exchange communications (e.g., packets) via network connection(s). For instance, the network connections may be transport control protocol (TCP) network connections or any network connection (e.g., information-centric networking (ICN)) that enable the network devices to exchange packets with other devices via the network connections. The network connections represent, for example, data paths between the devices of environment 100. It should be appreciated that the term “network connection” may also be referred to as a “network path.” The use of a cloud computing network in this example is not meant to be limiting. Other types of networks are contemplated in accordance with password linkage concepts, such as an enterprise system. In some examples, the security system 104 and/or computing device 106 may be considered part of a local area network, or a software defined wide area network (SD-WAN). A variety of architectures are envisioned for the manifestation of elements of security system 104. For instance, in some examples, grouper 124, group LLM 126, and/or IOC DB 128 may be manifest as an application or microservice running on one or more computing devices within the organization or within the same data center 110. In other examples, an element of security system 104 may run as a separate cloud-based service, relatively independent from other physical devices of security system 104.

In general, example environment 100 may be used to illustrate a scenario in which an email 132 (e.g., communication, email communication, message) is received at the security system 104. Although described as an email, the communication may represent a wide range of other communication formats, such as instant messages, texts, etc. Email 132 may have been sent from user device 102(1). The email 132 may be intended for delivery to a user and/or organization. The sending user device 102(1) may be external to the organization, such that the user device 102(1) may be referred to as an external device. In the example shown in FIG. 1A, the email 132 may include a variety of features, such as content 134 (e.g., email body, text, images, attachments) and/or metadata 136. Further, in some examples, email 132 may generally be viewed as a part of a data traffic flow that may include multiple emails and/or other communications arriving at intake 112 of security system 104 from one or more of the user devices 102.

The scenario depicted in environment 100 may include examples of communications between various devices and/or services offered by elements of environment 100. In FIGS. 1A and 1B the communications are indicated with circled numbers. For example, referring to FIG. 1A, at “Step 1,” user device 102 may send email 132 to intake 112. Thus, the email 132 from the external device has arrived at a service (e.g., intake 112) of security system 104. Note that in the example scenario depicted in FIGS. 1A and 1B, email 132 continues from intake 112 on to additional processing steps. In other examples, some communications may be allowed to continue to an intended recipient, such as computing device 106, without further processing or analysis, or with minimal analysis (not shown). In some examples, a security system may include other features, such as an analysis prioritization component, to determine whether communications such as email 132 may be selected for further analysis or simply forwarded to the intended recipient.

Continuing with the example scenario depicted in FIG. 1A, at “Step 2,” after receiving email 132, intake 112 may route the email 132 to converter 114 (e.g., text representation converter). Communications, such as email 132, may originally be represented in Multipurpose Internet Mail Extensions (MIME) or another email or communications format. Email 132 may need to be converted to a simpler string to facilitate analysis of the email content. For example, a MIME file may contain unnecessary information and/or the content 134 of email 132 may be encoded, such as in base64, and thus may be not directly visible. The converter 114 may create a simplified representation of the email 132. In some examples, the simplified representation may contain selected header fields (e.g., from, sender, to, cc, subject, etc.) and/or an Authentication-Results String representation of the content 134 (e.g., the email body). The email body is often formatted in html, in such a case the tags may be stripped and the email body may be converted to a markdown-like representation of the content 134. The simplified representation may also contain URLs, attachment filenames, and/or representations of various aspects of metadata 136. Stated another way, individual communication payloads can be converted into text using HTML parsers and related tools to obtain email text representations.

At “Step 3” of FIG. 1A, a text representation of email 132 may proceed to embedder 116. Embedder 116 may embed, or convert, the text representation of email 132 to vector 138, a vector representation of email 132 (e.g., email 132 represented by one or more vectors). Vector 138 is intended to retain the semantics of the message from email 132. Embedding of similar messages are expected to result in vectors with high cosine similarity and vice-versa. Various embedder models are contemplated for this task. For example, security system 104 may utilize a neural network-based embedding model to convert text into a numeric vector representation.

At “Step 4” of FIG. 1A, the vector 138 representing email 132 may be sent to context database 118. Vector 138 representing email 132 may be stored in context database 118 along with vector representations of other communications from the incoming data stream flow. Context database 118 may feature capability for embedding indexation. The storage of vector 138 in context database 118 may allow quick identification and retrieval of communications based on vector similarity to email 132. Thus, communications similar to email 132 may be efficiently located and retrieved from context database 118, via the associated vector representations, where a similarity is identified to the content 134 and/or metadata 136 of email 132. The values of vector 138 may correspond to various aspects of email 132, such as a header, subject, attachment filename, or URL. Further, context database 118 may be able to aggregate intelligence about emails by saving the embeddings along with a label 140, such as benign, malicious, phishing, BEC, etc. The label 140 may be derived from sources such as expert evaluations, customer feedback, prior flagged emails, or third-party intelligence. In some examples, the context database 118 can be a standalone database; in other examples, the context database 118 can be an in-memory data structure that supports vector search. The form of the context database 118 may be dependent on size (or required resources), for instance.

At “Step 5” of FIG. 1A, LLM classifier 120 may consider email 132 in a classification process. Security system 104 may find email 132 in context database 118 via vector search resulting in location of vector 138. Security system 104 may be able to leverage embeddings from context database 118 for similarity searches. Further, security system 104 may be able to retrieve labels from similar emails to support more informed decision-making. Note that in some examples, email 132 may proceed to LLM classifier 120 from converter 114 without having passed to the embedder 116. Routing of emails through the various elements of the security system 104 will be described in more detail below.

In some examples, LLM classifier 120 may be a generative LLM model. The generative LLM model may be provided with a prompt that includes one or more descriptions related to the classification task. For examples, the prompt may include a description of the classification task and/or the desired output categories. The prompt may include a description of the output format. In some instances, the output may consist of a limited amount of information, such as only the category name, to reduce latency of the model as it scales with the output size. The prompt may also include metadata about similar emails found in the context database 118. As such, the operation of LLM classifier 120 may be assisted or augmented by input from the context database 118. The prompt may include a text representation of a currently classified email. In some implementations, the LLM classifier 120 can classify emails in real-time. The emails may be classified into a certain number of pre-determined categories, such as Business Email Compromise (BEC), phishing, spam, or benign. In other examples, the emails may be classified in a more generalized way, such as a binary classification of threat versus no-threat. Note that the use of an LLM classifier in this example is not meant to be limiting. In other examples a different type of machine learning model, or a different classification process or element may be used by a security system to process communications.

At “Step 6” of FIG. 1A, output 122 may receive a result from LLM classifier 120. For example, LLM classifier 120 may classify email 132 as “benign.” In this instance, the output from LLM classifier 120 may be represented as labeled email 142, which may pass through output 122 and continue on toward an intended recipient represented by computing device 106. In another example email 132 may be labeled as “malicious.” In this instance, the output from LLM classifier 120 may be represented as labeled email 144, which may pass through output 122 and be placed in quarantine 130. Additionally or alternatively, an email may be labeled as malicious, but may be sent on to computing device 106 and appear in a junk mailbox, for instance.

Referring to FIG. 1B, at “Step 7,” security system 104 may wish to further investigate the flow of communications received from user devices 102. Grouper 124 may receive multiple communications from context database 118 and create a group 146 (e.g., grouping, cluster, batch) of emails to process. A wide variety of methods for creating groups of communications is envisioned. The grouping may be performed while ensuring that the grouping is computationally feasible. In one example, groups may be simply created by a predetermined number of consecutive incoming emails or other messages. In another example, groups of communications may be time-based. For instance, emails received at intake 112 over the span of one day may be grouped, for instance. In some examples, a clustering algorithm, such as agglomerativeclustering, may be used to perform the grouping. Additionally or alternatively, grouper 124 may further subdivide a group 146 for processing. For instance, grouper 124 may send a first subset of emails from group 146 to group LLM 126, and then a second subset, etc. The subsets may be determined based on a predetermined limit on the number of emails in a subset, or may be organized based on a commonality among emails in the subset. For instance, the emails selected for a subset may have a commonality related to a vector representation, an aspect of content (such as content 134), or an aspect of metadata (such as metadata 136).

At “Step 8” of FIG. 1B, group LLM 126 may receive group 146 (or a subset of group 146) for processing. Group LLM 126 may annotate (e.g., label) the group 146. For example, group LLM 126 may use a LLM to annotate individual emails of the group 146. Instruction to the LLM may include a prompt to detect general indicators of compromise (IOCs) and/or anomalies within the emails provided in the prompt. Within the context of a group 146, group LLM 126 may be able to identify a malicious campaign. Group LLM 126 may be able to identify a malicious campaign even when the commonality that defines the campaign is subtle or difficult to associate. For instance, group LLM 126 may be able to identify such a campaign even when a phishing or business email compromise (BEC) campaign employs multiple different email addresses. Thus, by feeding grouped communications into an LLM, the security system 104 may be able to achieve greater email classification success over a system that simply uses an LLM on individual emails, such as the function of LLM classifier 120.

The intelligence gathered through the function of group LLM 126 may be used by security system 104 in a variety of ways. For example, group LLM 126 may attach a label to email 132 based on a result of group LLM 126, represented as labeled email 148. In another instance, group LLM 126 may update a label that was previously assigned to email 132. Whether newly labeled or updated, referring to “Step 9” of FIG. 1B, labeled email 148 may be sent to output 122, so that security system 104 may direct labeled email 148 to the intended recipient at computing device 106 or quarantine 130, for instance. In another example, referring to “Step 10” of FIG. 1B, labeled email 148 may be fed back into context database 118, further enriching the system's knowledge base. New information entering context database 118 may add to, overwrite, or replace existing information. For instance, labeled email 148 may replace a previous version of the same communication. Therefore, annotation by group LLM 126 may directly influence the conviction of an email and will furthermore provide intelligence and context of IOCs that will be stored in context database 118. This may in turn be consumed by LLM classifier 120, improving the overall function of security system 104. Stated another way, the context database 118 records information from the grouper 124 and group LLM 126 processes and potentially updates existing label information.

Another use of the intelligence gathered through the function of group LLM 126 may be the identification of an indicator of compromise, represented as IOC 150. An IOC may be associated with email 132 and/or with the group 146 and discovered by group LLM 126. Examples of IOCs may include domain names, addresses, and subject lines. The IOC may have be subtle or non-obvious, for instance, emails may be sent from different addresses, but may have something else in common, such as a text phrase in the body of the email. For instance, a phishing email may have a lure, such text meant to draw a victim in to click or respond, and the group LLM 126 may discover that the lure is common to multiple emails in a group. At “Step 11” of FIG. 1B, the IOC 150 may be added to IOC DB 128, and/or passed along to context database 118. Note that IOC DB 128 may be part of the context database 118, or may be a separate entity or service. Once IOC 150 has been identified, it may be used by security system 104 to better identify other malicious emails, either examples contained in context database 118, suspicious emails held in quarantine 130, or new emails coming in through intake 112. In this manner, group LLM 126 helps to continually improve the accuracy and efficiency of security system 104 by learning new evidence to better label potentially malicious communications.

In general, the approach of grouping combined with leveraging a large language model is expected to improve the detection of phishing and BEC attacks through several mechanisms. The improvements include the efficiency of label propagation within a group, where other emails in the group may receive the same label. The improvements include enabling more accurate classifications, where finding a malicious campaign in a group helps improve confidence of an individual label for a communication. The improvements include better detection of more subtle IOCs, such as by utilizing the richer context provided within groups. For instance, grouping can help identify initial lures that are semantically very close and would be more difficult to detect as malicious in isolated instances. The improvements include anomaly detection through querying the context database 118 or the identification of groups containing only a few elements. The improvements include detection of advanced campaigns that may be coming from multiple domains, which addresses the limitations of methods that rely solely on burst detection from a single email address or domain.

Note, the context database 118 may not necessarily contain a record for every email processed. In some examples, emails passing through intake 112 may be directed to the converter 114, then embedder 116, then be stored in context database 118. In other examples, not all emails are directed to the converter 114 or stored in the context database 118. For instance, context database 118 may contain a record for emails that are potentially impactful for future decisions, and/or where intelligence is known about a true label of an email. Thus, some of the emails may follow Steps 2 through 6 of FIG. 1A, while other emails may proceed from the converter 114 to the LLM classifier 120. In some cases, emails may follow both paths. An email may be referred to the context database 118 after a classification result from LLM classifier 120 identifies the email as malicious, or identifies the email as belonging to an important category of malicious email types, or as a helpful example of a benign email. For instance, the classification result from LLM classifier 120 may indicate that the email belongs to an unusual class of malicious email that does not have enough examples stored in the context database 118, and therefore refer the email to the context database 118 as an example. In some examples, a classified email from output 122 may be directed back to embedder 116 for processing and inclusion in context database 118.

In some implementations, other input may cause a classified email to be added to the context database 118. For instance, email 132 may be classified as malicious by LLM classifier 120, then may be labeled as malicious and pass through the security system 104 and out to computing device 106. In this instance email 132 may appear in the junk mailbox of a user of computing device 106, or may be viewed by an administrator. The user (or administrator) may provide input indicating that the classification of email 132 as malicious was, in fact, correct. This input may be received by security system 104, which in response may direct email 132 to be added to the context database 118 as a confirmed example of a malicious email (e.g., high confidence as a malicious example), which may help with future classifications by LLM classifier 120.

Thus, apart from storing emails in vector form, the context database 118 may include user feedback on an email (e.g., affirmation of classification, false positive, false negative, etc.). Similarly, the context database 118 may include other associated information, such as when an email is identified as malicious through an offline or external system. For instance, IOCs or other evidence of a data breach related to the email may have appeared in a trusted threat intelligence feed.

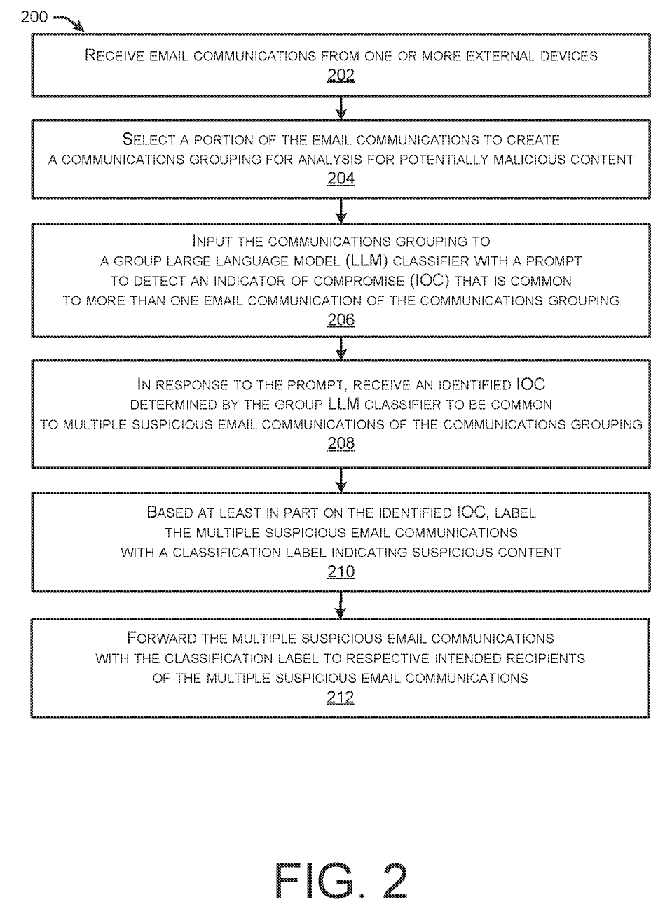

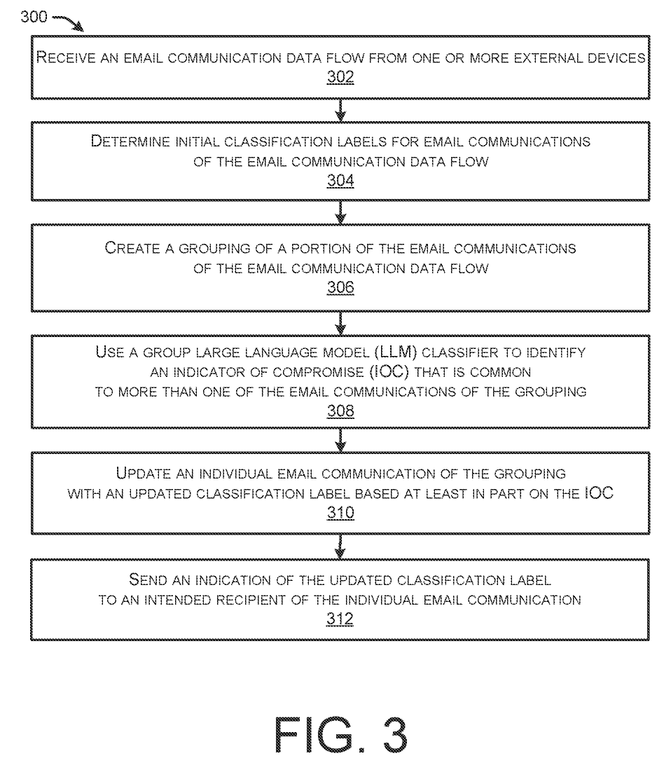

FIGS. 2 and 3 illustrate flow diagrams of example methods 200 and 300 that include functions that may be performed at least partly by security system or service, such as security system 104, described relative to FIGS. 1A and 1B. The logical operations described herein with respect to FIGS. 2 and 3 may be implemented (1) as a sequence of computer-implemented acts or program modules running on a computing system and/or (2) as interconnected machine logic circuits or circuit modules within the computing system. In some examples, the method(s) 200 and/or 300 may be performed by a system comprising one or more processors and one or more non-transitory computer-readable media storing computer-executable instructions that, when executed by the one or more processors, cause the one or more processors to perform the method(s) 200 or 300.

The implementation of the various devices and/or components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations might be performed than shown in the FIGS. 2 and 3 and described herein. These operations may also be performed in parallel, or in a different order than those described herein. Some or all of these operations may also be performed by components other than those specifically identified. Although the techniques described in this disclosure is with reference to specific devices and/or services, in other examples, the techniques may be implemented by less devices, more devices, different devices, or any configuration of devices and/or components.

FIG. 2 illustrates a flow diagram of an example method 200 for network devices to perform communications grouping techniques to improve email security. Method 200 may be performed by a security system (e.g., security system 104) communicatively coupled to at least one external user device (e.g., user device 102) and one or more computing devices (e.g., computing device 106), for instance.

At 202, method 200 may include receiving email communications from one or more external devices. The email communications may be originating from any number of sending users and devices. The emails many be intended for one or more recipients within an organization or other network.

At 204, method 200 may include selecting a portion of the email communications to create a communications grouping for analysis for potentially malicious content. In some examples, the email communications may be embedded as vector representations, which may be stored in a context database. In other examples, the portion of the email communications may be selected for processing to vector representations and storage for later use. The grouping may include selecting the portion of the email communications based at least in part on a time window (e.g., time period). For instance, all emails from a particular hour, day, week, or month may be grouped for analysis. The time period may be related to a volume of emails typically received over time. In other cases, the grouping may be based on a predetermined number of emails, such as a certain number of emails received consecutively. Additionally or alternatively, the grouping may include selecting the portion of the email communications using agglomerative clustering. The examples described here for the basis of the grouping are not meant to be limiting, the grouping may be based on some other criteria.

At 206, method 200 may include inputting the communications grouping to a group large language model (LLM) classifier. The input may also include a prompt to detect an indicator of compromise (IOC). For example, the group LLM classifier may be prompted to try to find an IOC that is common to more than one email communication of the communications grouping.

At 208, method 200 may include receiving an identified IOC. In some examples, the IOC may be identified in response to the prompt that was input to the group LLM classifier. More specifically, the IOC may have been determined by the group LLM classifier to be common to multiple suspicious email communications of the communications grouping. In some examples, the method may further include storing the identified IOC in an IOC database and/or the context database.

At 210, method 200 may include labeling the multiple suspicious email communications with a classification label. The labeling may be based at least in part on the identified IOC. The classification label may indicate suspicious content. The classification label may more explicitly identify the email as a malicious email. In some examples, the multiple suspicious email communications may be stored in association with the classification label, such as in the context database. Further, labeling a particular email of the multiple suspicious email communications may include updating a previous benign classification label of the particular email with a new malicious classification label.

At 212, method 200 may include forwarding the multiple suspicious email communications with the classification label to respective intended recipients of the multiple suspicious email communications. For instance, a suspicious email may be delivered to a junk mail folder. In some examples, the classification label may cause an alert to be displayed to a user or an administrator regarding potentially malicious content, and/or indicate to the user to proceed with caution.

In some examples, method 200 may further include receiving an additional email communication from the one or more external devices. Based at least in part on the identified IOC, the method may include classifying the additional email communication as suspicious. In some examples, the identified IOC may be accessed from a database for use in classifying the additional email communication. Further, method 200 may include adding the classification label to the additional email communication. Additionally, based at least in part on the identified IOC, an existing label of at least one previously received email communication may be updated with the classification label. For instance, after identifying the IOC, the security system may learn of a new malicious campaign, and may review previously received emails. In some instances, the security system may retrieve an email that has already been delivered to an intended recipient. For example, the security system may cause a delivered email to move from an inbox of a user to the junk mail folder.

FIG. 3 illustrates a flow diagram of an example method 300 for network devices to perform communications grouping techniques to improve email security. Method 300 may be performed by a security system (e.g., security system 104) communicatively coupled to at least one external user device (e.g., user device 102) and one or more computing devices (e.g., computing device 106), for instance.

At 302, method 300 may include receiving an email communication data flow from one or more external devices. The email communication data flow may be a continuing stream of emails coming from one or more sending users and may come from one or more sending devices. The emails many be intended for one or more recipients within an organization or other network.

At 304, method 300 may include determining initial classification labels for email communications of the email communication data flow. For instance, the security system may be able to easily recognize one or more emails as malicious, and label them as such. Easily identified malicious emails may be quarantined without proceeding to the inbox of a user, for instance. Many incoming emails may be labeled as benign initially. Some emails may be flagged as suspicious, and/or referred for further analysis.

At 306, method 300 may include creating a grouping of a portion of the email communications of the email communication data flow. The purpose of the grouping may be further analysis of the portion of the emails.

At 308, method 300 may include using a group large language model (LLM) classifier to identify an indicator of compromise (IOC) that is common to more than one of the email communications of the grouping. In some examples, analyzing the emails as a group may illuminate a subtle pattern, common feature, or anomaly that suggests the emails are suspicious. Note that the email communications originate from different sender email addresses, and the group LLM classifier may be able to find an IOC that is common to more than one of the email communications despite the different origination addresses. Method 300 may also include storing the IOC in a database.

At 310, method 300 may include updating an individual email communication of the grouping with an updated classification label. The updated classification label may be based at least in part on, or related to, the IOC. In some examples, the initial classification labels may comprise benign classification labels, while the updated classification label comprises a malicious classification label. Stated another way, the security system may have initially passed an email as benign, but upon further investigation using the communication grouping techniques, the security system may discover that the email is actually malicious, and update the respective label.

At 312, method 300 may include sending an indication of the updated classification label to an intended recipient of the individual email communication. In some examples, the method may also include using the IOC to review or classify other email communications. For instance, the IOC may be accessed from the database to classify an additional incoming email communication of the email communication data flow.

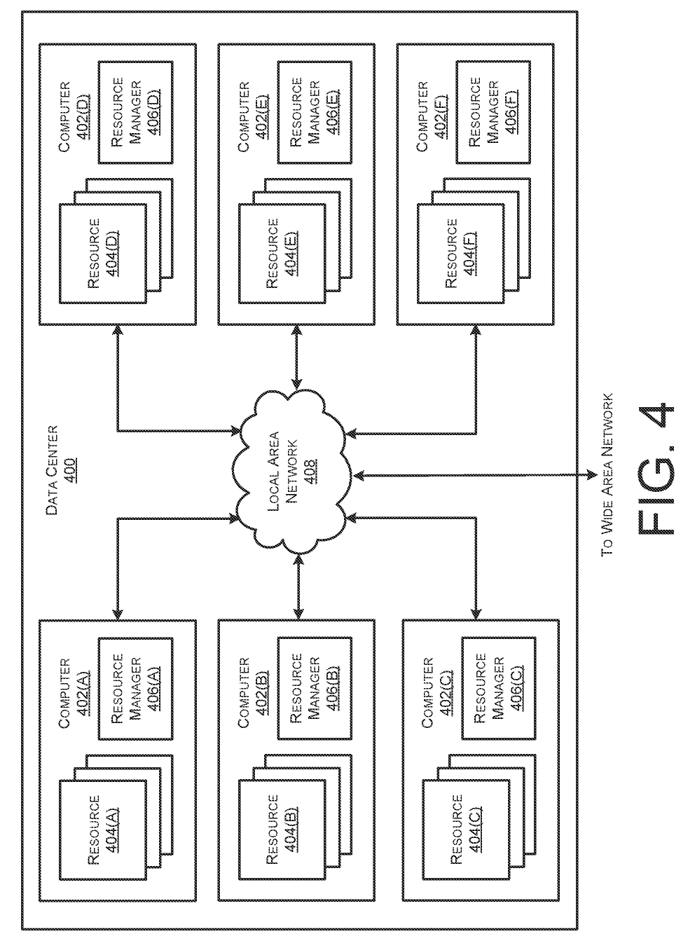

FIG. 4 is a computing system diagram illustrating a configuration for a data center 400 that can be utilized to implement aspects of the technologies disclosed herein. For instance, data center 400 may represent data center 110 described above relative to FIGS. 1A and 1B. The example data center 400 shown in FIG. 4 includes several computers 402A-402F (which might be referred to herein singularly as “a computer 402” or in the plural as “the computers 402”) for providing computing resources. In some examples, the resources and/or computers 402 may include, or correspond to, any type of networked device described herein, such as user device 102, routers, mobile devices, and/or any of computing devices 106. Although, computers 402 may comprise any type of networked device, such as servers, switches, routers, hubs, bridges, gateways, modems, repeaters, access points, hosts, etc.

The computers 402 can be standard tower, rack-mount, or blade server computers configured appropriately for providing computing resources. In some examples, the computers 402 may provide computing resources 404 including data processing resources such as virtual machine (VM) instances or hardware computing systems, database clusters, computing clusters, storage clusters, data storage resources, database resources, networking resources, and others. Some of the computers 402 can also be configured to execute a resource manager 406 capable of instantiating and/or managing the computing resources. In the case of VM instances, for example, the resource manager 406 can be a hypervisor or another type of program configured to enable the execution of multiple VM instances on a single computer 402. Computers 402 in the data center 400 can also be configured to provide network services and other types of services.

In the example data center 400 shown in FIG. 4, an appropriate local area network (LAN) 408 is also utilized to interconnect the computers 402A-402F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 400, between each of the computers 402A-402F in each data center 400, and, potentially, between computing resources in each of the computers 402. It should be appreciated that the configuration of the data center 400 described with reference to FIG. 4 is merely illustrative and that other implementations can be utilized.

In some examples, the computers 402 may each execute one or more application containers and/or virtual machines to perform techniques described herein. For instance, the containers and/or virtual machines may serve as server devices, user devices, and/or routers in the networked computing environment 108.

In some instances, the data center 400 may provide computing resources, like application containers, VM instances, and storage, on a permanent or an as-needed basis. Among other types of functionality, the computing resources provided by a cloud computing network may be utilized to implement the various services and techniques described above. The computing resources 404 provided by the cloud computing network can include various types of computing resources, such as data processing resources like application containers and VM instances, data storage resources, networking resources, data communication resources, network services, and the like.

Each type of computing resource 404 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 404 not mentioned specifically herein.

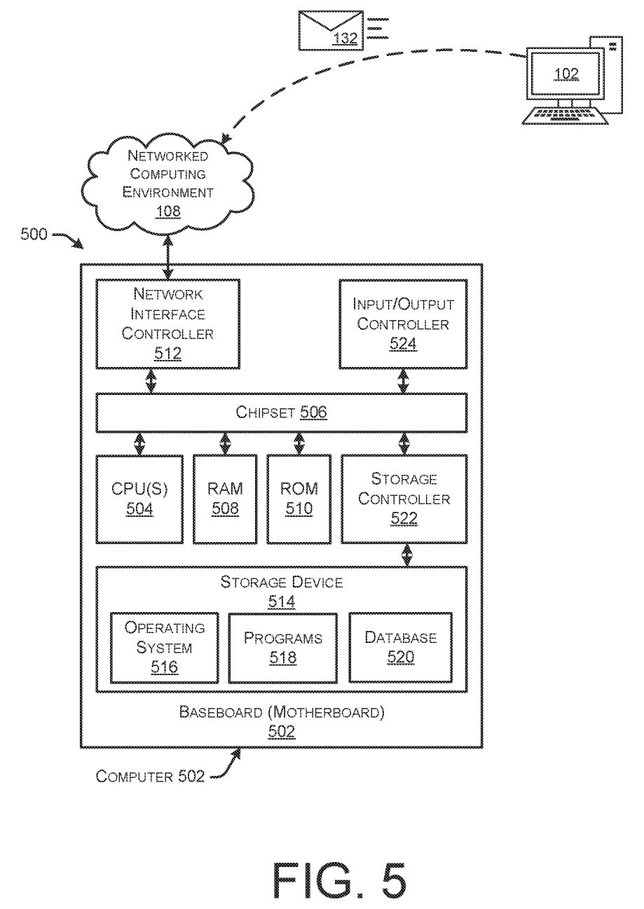

The computing resources 404 provided by a cloud computing network may be enabled in one embodiment by one or more data centers 400 (which might be referred to herein singularly as “a data center 400” or in the plural as “the data centers 400”). The data centers 400 are facilities utilized to house and operate computer systems and associated components. The data centers 400 typically include redundant and backup power, communications, cooling, and security systems. The data centers 400 can also be located in geographically disparate locations. One illustrative embodiment for a data center 400 that can be utilized to implement the technologies disclosed herein will be described below with regards to FIG. 5.

FIG. 5 shows an example computer architecture 500 for a computer 402 capable of executing program components for implementing the functionality described above. The computer architecture 500 shown in FIG. 5 illustrates a conventional server computer, workstation, desktop computer, laptop, tablet, network appliance, e-reader, smartphone, and/or other computing device, and can be utilized to execute any of the software components presented herein. The computer 402 may, in some examples, correspond to a physical device described herein (e.g., user device, computing device, device in a networked computing environment and/or data center, etc.), and may comprise networked devices such as servers, switches, routers, hubs, bridges, gateways, modems, repeaters, access points, etc. For instance, computer 402 may correspond to a device within data center 110.

As shown in FIG. 5, the computer 402 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 402.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 402. The chipset 506 can further provide an interface to a computer-readable storage medium such as a read-only memory (“ROM”) 510 or non-volatile RAM (“NVRAM”) for storing basic routines that help to start up the computer 402 and to transfer information between the various components and devices. The ROM 510 or NVRAM can also store other software components necessary for the operation of the computer 402 in accordance with the configurations described herein.

The computer 402 can operate in a networked environment using logical connections to remote computing devices and computer systems through a network, such as networked computing environment 108, etc. The chipset 506 can include functionality for providing network connectivity through a network interface controller (NIC) 512, such as a gigabit Ethernet adapter. The NIC 512 is capable of connecting the computer 402 to other computing devices over the networked computing environment 108. For instance, in the example shown in FIG. 5, NIC 512 may help facilitate transfer of data, packets, and/or communications (indicated by email 132 in FIG. 5) over the networked computing environment 108 with computer 402. It should be appreciated that multiple NICs 512 can be present in the computer 402, connecting the computer to other types of networks and remote computer systems.

The computer 402 can be connected to a storage device 514 that provides non-volatile storage for the computer. The storage device 514 can store an operating system 516, programs 518, a database 520 (e.g., context database 118, IOC DB 128), and/or other data. The storage device 514 can be connected to the computer 402 through a storage controller 522 connected to the chipset 506, for example. The storage device 514 can consist of one or more physical storage units. The storage controller 522 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 402 can store data on the storage device 514 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 514 is characterized as primary or secondary storage, and the like.

For example, the computer 402 can store information to the storage device 514 by issuing instructions through the storage controller 522 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 402 can further read information from the storage device 514 by detecting the physical states or characteristics of one or more particular locations within the physical storage units.

In addition to the mass storage device 514 described above, the computer 402 can have access to other computer-readable storage media to store and retrieve information, such as policies, program modules, data structures, and/or other data. It should be appreciated by those skilled in the art that computer-readable storage media is any available media that provides for the non-transitory storage of data and that can be accessed by the computer 402. In some examples, the operations performed by the networked computing environment 108, and/or any components included therein, may be supported by one or more devices similar to computer 402. Stated otherwise, some or all of the operations performed by the networked computing environment 108, and or any components included therein, may be performed by one or more computer devices 402 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, ternary content addressable memory (TCAM), and/or other optical storage, magnetic cassettes, magnetic tape, magnetic disk storage or other magnetic storage devices, or any other medium that can be used to store the desired information in a non-transitory fashion.

As mentioned briefly above, the storage device 514 can store an operating system 516 utilized to control the operation of the computer 402. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 514 can store other system or application programs and data utilized by the computer 402.

In one embodiment, the storage device 514 or other computer-readable storage media is encoded with computer-executable instructions which, when loaded into the computer 402, transform the computer from a general-purpose computing system into a special-purpose computer capable of implementing the embodiments described herein. These computer-executable instructions transform the computer 402 by specifying how the CPUs 504 transition between states, as described above. According to one embodiment, the computer 402 has access to computer-readable storage media storing computer-executable instructions which, when executed by the computer 402, perform the various processes described above with regards to FIGS. 1A-3. The computer 402 can also include computer-readable storage media having instructions stored thereupon for performing any of the other computer-implemented operations described herein.

The computer 402 can also include one or more input/output controllers 524 for receiving and processing input from a number of input devices, such as a keyboard, a mouse, a touchpad, a touch screen, an electronic stylus, or other type of input device. Similarly, an input/output controller 524 can provide output to a display, such as a computer monitor, a flat-panel display, a digital projector, a printer, or other type of output device. It will be appreciated that the computer 402 might not include all of the components shown in FIG. 5, can include other components that are not explicitly shown in FIG. 5, or might utilize an architecture completely different than that shown in FIG. 5.

As described herein, the computer 402 may comprise one or more devices, such as a user device 102, computing device 106, any device of networked computing environment 108 and/or data center(s) 110, and/or other devices. The computer 402 may include one or more hardware processors 504 (processors) configured to execute one or more stored instructions. The processor(s) 504 may comprise one or more cores. Further, the computer 402 may include one or more network interfaces configured to provide communications between the computer 402 and other devices, such as the communications described herein as being performed by a user device 102, computing device 106, any device of networked computing environment 108 and/or data center(s) 110, and/or other devices. In some examples, the communications may include email, attachment, messages data, packet, instructions, policy, and/or other information transfer, for instance. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 518 may comprise any type of programs or processes to perform the techniques described in this disclosure in accordance with communications grouping techniques. For instance, the programs 518 may cause the computer 402 to perform techniques for communicating with other devices using any type of protocol or standard usable for determining connectivity. Additionally, the programs 518 may comprise instructions that cause the computer 402 to perform the specific techniques for improving email security through communications grouping.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving email communications from one or more external devices;
selecting a portion of the email communications to create a communications grouping for analysis for potentially malicious content;
inputting the communications grouping to a group large language model (LLM) classifier with a prompt to detect an indicator of compromise (IOC) that is common to more than one email communication of the communications grouping;
in response to the prompt, receiving an identified IOC determined by the group LLM classifier to be common to multiple suspicious email communications of the communications grouping;
based at least in part on the identified IOC, labeling the multiple suspicious email communications with a classification label indicating suspicious content; and
forwarding the multiple suspicious email communications with the classification label to respective intended recipients of the multiple suspicious email communications.

2. The computer-implemented method of claim 1, further comprising:
receiving an additional email communication from the one or more external devices;
based at least in part on the identified IOC, classifying the additional email communication as suspicious; and
adding the classification label to the additional email communication.

3. The computer-implemented method of claim 2, further comprising:
storing the identified IOC in an IOC database; and
accessing the IOC database to use the identified IOC to classify the additional email communication.

4. The computer-implemented method of claim 1, further comprising:
embedding the multiple suspicious email communications as vector representations; and
storing the vector representations of the multiple suspicious email communications in association with the classification label in a context database.

5. The computer-implemented method of claim 1, further comprising:
selecting the portion of the email communications to create the communications grouping based at least in part on a time window.

6. The computer-implemented method of claim 1, further comprising:
labeling a particular email of the multiple suspicious email communications with the classification label, based at least in part on the identified IOC, by updating a previous benign classification label of the particular email.

7. The computer-implemented method of claim 1, wherein the selecting the portion of the email communications to create the communications grouping comprises agglomerative clustering.

8. The computer-implemented method of claim 1, further comprising:
based at least in part on the identified IOC, updating an existing label of at least one previously received email communication with the classification label.

9. A security system comprising:
one or more processors; and
one or more non-transitory computer-readable media storing computer-executable instructions that, when executed by the one or more processors, cause the one or more processors to:
receive email communications from one or more external devices;
select a portion of the email communications to create a communications grouping for analysis for potentially malicious content;
input the communications grouping to a group large language model (LLM) classifier with a prompt to detect an indicator of compromise (IOC) that is common to more than one email communication of the communications grouping;
in response to the prompt, receive an identified IOC determined by the group LLM classifier to be common to multiple suspicious email communications of the communications grouping;
based at least in part on the identified IOC, label the multiple suspicious email communications with a classification label indicating suspicious content; and
forward the multiple suspicious email communications with the classification label to respective intended recipients of the multiple suspicious email communications.

10. The security system of claim 9, wherein the computer-executable instructions further cause the one or more processors to:
receive an additional email communication from the one or more external devices;
based at least in part on the identified IOC, classify the additional email communication as suspicious; and
add the classification label to the additional email communication.

11. The security system of claim 10, wherein the computer-executable instructions further cause the one or more processors to:
store the identified IOC in an IOC database; and
access the IOC database to use the identified IOC to classify the additional email communication an additional email communication from the one or more external devices.

12. The security system of claim 9, wherein the computer-executable instructions further cause the one or more processors to:
embed the multiple suspicious email communications as vector representations; and
store the vector representations of the multiple suspicious email communications in association with the classification label in a context database.

13. The security system of claim 9, wherein the computer-executable instructions further cause the one or more processors to:
select the portion of the email communications to create the communications grouping based at least in part on a time window.

14. The security system of claim 9, wherein the computer-executable instructions further cause the one or more processors to:
label a particular email of the multiple suspicious email communications with the classification label, based at least in part on the identified IOC, by updating a previous benign classification label of the particular email.

15. The security system of claim 9, wherein selecting the portion of the email communications to create the communications grouping comprises agglomerative clustering.

16. The security system of claim 9, wherein the computer-executable instructions further cause the one or more processors to:
based at least in part on the identified IOC, update an existing label of at least one previously received email communication with the classification label.

17. A method comprising:
receiving an email communication data flow from one or more external devices;
determining initial classification labels for email communications of the email communication data flow;
creating a grouping of a portion of the email communications of the email communication data flow;
using a group large language model (LLM) classifier to identify an indicator of compromise (IOC) that is common to more than one of the email communications of the grouping;
updating an individual email communication of the grouping with an updated classification label based at least in part on the IOC; and
sending an indication of the updated classification label to an intended recipient of the individual email communication.

18. The method of claim 17, further comprising:
storing the IOC in a database; and
accessing the IOC to classify an additional incoming email communication of the email communication data flow as a suspicious email.

19. The method of claim 17, wherein the initial classification labels comprise benign classification labels and the updated classification label comprises a malicious classification label.

20. The method of claim 17, wherein the IOC is common to more than one of the email communications of the grouping and the more than one of the email communications originate from different sender email addresses.
